(19) United States
(12) Patent Application Publication
(10) Pub. No.: US 2003/0184954 A1
(43) Pub. Date: Oct. 2, 2003

(54) Separation module and method for producing the same

(76) Inventors: Gundula Fischer, Stadtroda (DE); Erik Tusel, Homburg/Saar (DE); Ingolf Voight, Jena (DE); Baerbel Voightsberger, Bad Klosterlausnitz (DE)

Correspondence Address: JORDAN AND HAMBURG LLP, 122 EAST 42ND STREET, SUITE 4000, NEW YORK, NY, 10168, US

(21) Appl. No.: 10/276,891

(22) PCT Filed: May 19, 2001
(86) PCT No.: PCT/EP01/06036

(30) Foreign Application Priority Data
May 19, 2000 (DE) 100 24 406.8

(51) Int. Cl. H01G 9/04

(52) U.S. Cl. 361/511

(57) ABSTRACT

The aim of the invention is to provide a separation module that does not have the disadvantages of metal, glass or plastic housings and that at the same time allows to produce a separation layer that is as flawless as possible. To this end, the inventive separation module comprising a housing and a separation element retained thereby. The invention is further characterized in that a) the separation module is composed of a housing produced from a dense ceramic material and of separation element supports produced from a porous ceramic material; b) the separation element supports are coated with a separation layer either on the feed side or on the permeate side thereof, and c) the separation layer is applied on the separation element supports after the fully ceramic separation module has been assembled. The inventive product is especially but not exclusively useful in chemical process engineering in the broader sense thereof.

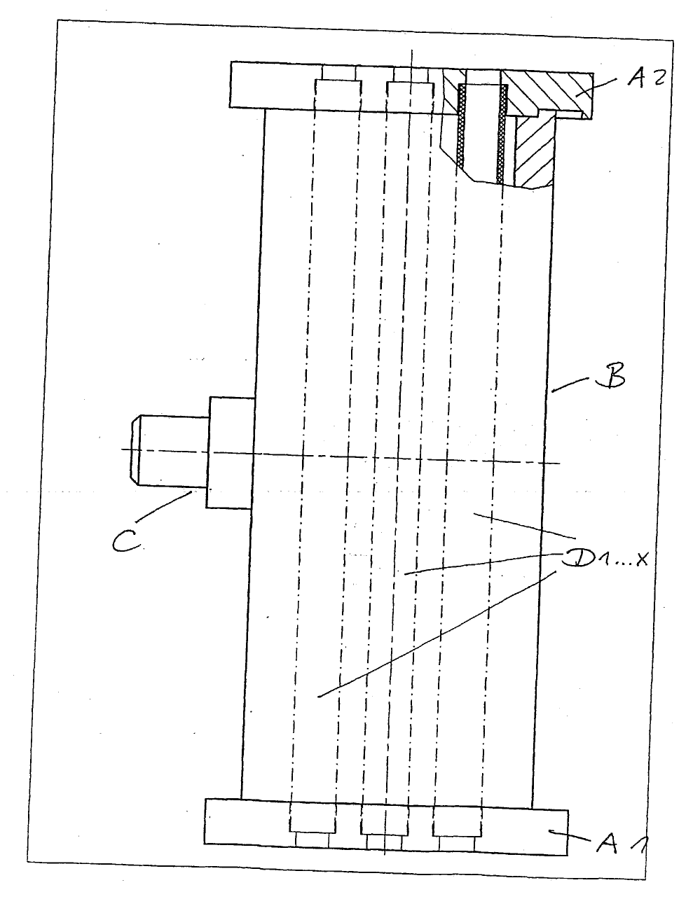

The invention relates to a separation module with porous, inorganic, nonmetallic separation elements, as well as to a method for producing the same. The main, but not the exclusive area of application of this separation module is the separation of solids or molecules from liquid and gases. The material of the separation module shall also withstand aggressive solids, liquids and/or gases.

Aside from conventional thermal or chemical methods, membrane methods are used to an increasing extent to separate materials in chemical process technology. This method is constantly becoming more interesting due to the development of microporous ceramic membranes, which are resistant to solvents and high temperatures.

The modular constructions for tubular, porous, ceramic separation elements have so far consisted exclusively of metallic housing. Essentially, these modules differ in the nature and manner, in which the separation elements are sealed and installed in the housing.

According to the generally known state of the art, the different materials are sealed with conventional O rings. Moreover, the ends of the filter elements can be sealed from the housing by means of specially cast elastomeric caps (EP 0 270 051 B1).

Furthermore, it is possible to seat metallic connectors on the ends of the separation elements as a transition between the separation element and the housing. Moreover, the connectors or the housing itself are connected either by adhesion or positively with metal-infiltrated ends of porous separation elements (WO 99/32 208) or with a suitable ceramic adhesive. The object of these seals is, on the one hand, to separate the permeate side from the retentate side in the module and, on the other, to compensate for the different coefficients of expansion of the housing and the separation element. The latter can be attained only to a limited extent.

For many applications, metallic materials cannot be used as traditional housing material because of the danger of catalytic side reaction. However, especially for use in membrane reactors, in which the catalytic reaction and the separation of materials are combined, the potential for using ceramic microporous membranes is very high. Because of its tendency to break, glass is not suitable, for example, for pressure-driven filtrations. Plastics are eliminated because of their inadequate stability towards organic solvents or their limited resistance to high temperatures.

In completely ceramic separation modules, materials can be employed, which satisfy the requirements of chemical separation processes (resistance to chemicals and high temperatures) and those of the separating method (pressure).

For all known modular constructions, completely coated separation elements are inserted into the housing. Especially in the case of externally coated filter elements, the installation in the housing is very expensive and complicated, since the membranes (separation layers) are easily scratched during the installation and, with that, become useless.

In the case of a completely ceramic separation module, the coefficients of expansion of the housing, the connecting site and the separation element must be matched to one another exactly. The use of such modules at higher temperatures is therefore not a problem. On the other hand, in the case of conventional modular concepts, the very different coefficients of expansion of the metallic housing and the ceramic separation elements make the use of such modules at higher temperatures possible only to a limited extent.

It is therefore an object of the invention, to create a separation module, which does not have said disadvantages of metallic housings, glass housings or plastic housings, and, at the same time, makes it possible to produce a separation layer, which is as free of damage as possible.

This objective is accomplished by the invention described in the claims.

Before the filter-active membranes (separation layers) are built into the housing, the porous separation elements are connected with the impermeable ceramic housing. During the subsequent coating processes, all separation elements are coated simultaneously. Several separation layers can also be applied consecutively.

The materials used for the impermeable modular housing are inorganic, nonmetallic materials. The coefficient of expansion of the material is matched to that of the separation element. The separation elements are individual tubes or hollow fibers of any external diameter, bundles of several tubes or hollow fibers or multichannel tubes with any number of channels in the longitudinal direction. They consist of individual oxides of the metals, transition metals or rare earths or their mixtures with an open porosity between 10% and 80% and an average pore size of less than 10 μm (supports), optionally coated with an inorganic, nonmetallic membrane on the inside or the outside of the tubes or hollow fibers or in the channels of the multichannel tubes. The membranes consist of an amorphous or crystalline oxides of the metals, transition metals or rare earths or their mixtures with an open porosity of less than 70% and an average pore size of less than 6 μm. The separation effect of the membranes is based on the size exclusion of the molecules or particles at the membranes, electrochemical interactions of molecules or particles with the membrane, ion conduction or the mixed conduction of the membrane or on the combinations of these interactions.

The invention is described by the following examples, and on the basis of the drawing. The attached drawing shows a diagrammatic construction of an inventive separation module.

### EXAMPLE 1

Starting out from the mullite support tubes D, a steatite is selected as material for the housing of the parts A1, A2 and B, the coefficient of expansion of which is matched to that of the tubes D. The steatite is plasticized with a system of binders, lubricants and water. Blanks are extruded from the composition and subsequently dried slowly, first under a sheet and then in air at 15° to 30° C. to a moisture content of less than 3%. The parts A1-Dx are produced by white processing. The steatite pairs are sintered at 1270°-1300° C. and holding times of 30-300 minutes. The dimensional deviations after the sintering must be the less than 0.5% and the open porosity smaller than 1%. The sintered parts and the tubes are joined by means of matched glass pastes, which solidify after the joints are formed at 1100° C. or 850° C. The joints are formed in the corresponding sequence:

1. Parts A1 with B and D1 . . . x and A2

2. Part B with a permanent connection C

After the joints are formed, the tubes (separation element supports) in a separation module are coated with a partially hydrolyzed tetraethyl orthosilicate sol. For the inner coating, the sol is filled into the tubes over the flange connections A1 or A2. The sol is deposited as a gel on the inside of the tubes, is dried and subsequently sintered at 400° to 600° C. in an oxidizing atmosphere. The thickness of the resulting silicate membrane is less than 500 nm. The membrane has an open porosity of less than 60% and a pore size of less than 1 nm. For the external coating, the sol is added over the permeate connection C into the interior of the module. The sol is deposited on the outside of the tubes and dried. The subsequent technological steps correspond to those described for the internal coating.

### EXAMPLE: 2

Starting out from the support tubes D of aluminum oxide, a pure clay china is selected as housing material, the coefficient of expansion of which is matched to that of the tubes. The pure clay china is plasticized with a system of binders, lubricants and water. The parts A1-C are turned from the composition and subsequently dried slowly under a sheet. A1 and C are attached by trimming before the sintering. All pure clay china parts are sintered at temperatures of 1350° to 1450° C. and holding times of 30 minutes to 300 minutes. The dimensional deviations after the sintering must be less than 0.5% and the open porosity smaller than 1%. The sintered parts and the tubes are joined by means of ceramic adhesives in the corresponding sequence:

1. Parts A1 and B with D1 . . . x and A2

2. Combination of 1. with C

After the joints are formed, the tubes in the separation module are coated with a solution consisting of tetrapropylammonium bromide colloidal silica sol and a sodium hydroxide solution. For the inner coating, the solution is filled into the tubes over flange connections A1 or A2. On the inside of the tubes, a silicate membrane crystallizes under hydrothermal conditions in 6 hours to 72 hours at 150° to 180° C. The resulting membrane has an average thickness of less than 30 μm, an open porosity of 65% and an average pore size of 0.51 nm. For the external coating, the solution is added to the interior of the module over the permeate connection C. A layer is deposited on the outside of the tubes and dried. The subsequent technological steps correspond to those described for the internal coating.

1. A separation module, consisting of a housing and of separation elements, held by the housing, characterized in that
a) the separation module is joined together from a housing of an impermeable ceramic and, within the housing, separation element supports of porous ceramic,
b) the separation element supports are coated on the feed side or on the permeate side with a separation layer and
c) the separation layer is applied on the separation element supports after the fully ceramic separation module is jointed.

2. The separation nodule of claim 1, characterized in that the separation layer consists of a suitable organic or inorganic material.

3. The separation module of one of the previous claims, characterized in that it is constructed in the form of a tubular heat exchanger, the tubes, preferably in the form of capillaries, single channel tubes, multichannel tubes or annular tubes, form the separation element supports and the housing consists of perforated end plates, in which the tubes are inserted, as well as of a preferably cylindrical outer casing.

4. The separation module of claim 3, characterized in that the walls of the capillaries and of the channels are disposed on the feed side of the tubes.

5. The separation module of claim 3, characterized in that the outer surface of the tubes and the outer surface and inner surface of the annular tube are disposed on the feed side.

6. The separation module of claims 1 and 2, characterized in that the module has separation pockets (hollow disks) disposed at a distance from one another, the individual separation pockets forming the separation element supports, which have one or more boreholes and the housing consisting of perforated ceramic tubes, on which the separation pockets are threaded, as well as of a preferably cylindrical or rectangular outer casing.

7. The separation module of claim 6, characterized in that the outer surfaces of the separation pockets are disposed on the feed side and provided with a separation layer, so that the permeate can be discharged through the holes of the perforated ceramic tubes.

8. The separation module of claims 1 and 2, characterized in that the module has multi-channel plates, which are disposed at a distance from one another, the individual multi-channel plates forming the separation element supports and the housing consisting of slotted and perforated end plates, in which the multi-channel plates are inserted, as well as of a preferably cylindrical outer casing.

9. The separation module of claim 8, characterized in that the channels of the multi-channel plates are disposed on the feed side.

10. The separation module of claim 8, characterized in that the outer surfaces of the multi-channel plates are disposed on the feed side.

11. A method for the production of a separation module of one of the previous claims, characterized in that the individual ceramic parts of the separation module are joined in a state, in which they have the hardness of leather, or in the fired state and the separation layer is produced subsequently by coating.

12. The method of claim 11, characterized in that, initially, the individual ceramic parts are joined by adhesion and, optionally, the firing of the leather-hard individual parts to fired ceramic is carried out at temperatures, usually employed for these methods, whereupon the coating takes place and subsequently the separation layer is formed therefrom by a heat treatment at temperatures lower than the connecting and firing temperatures.

13. The method of claims 11 or 12, characterized in that the joints are made by means of ceramic joint films, which, in the case of the separation pockets stack, act at the same time as spacers.

14. The method of claims 11 or 12, characterized in that the joints are formed by ceramic-containing or glass-containing slurries or pastes.

15. The method of claims 11 to 14, characterized in that the coating is formed by applying a ceramic slurry and firing it.

16. The method of claims 11 to 14, characterized in that the coating is formed by a sol-gel method.

17. The method of claim 16, characterized in that a coating solution is filled into the jointed module, the module is closed and the temperature is increased, so that hydro-thermal conditions result, which are suitable for producing zeolite membrane layers.

18. The method of claim 17, characterized in that the formation of the coating is supported by rotating about the own axis or about a different axis.

19. The method of claim 17, characterized in that the coating is sustained by pumping.

20. The method of claim 17, characterized in that the hydrothermal coating conditions are assisted by suitable radiation, preferably by microwaves.

21. The method of claims 11 to 14, characterized in that a metallic, polymeric or organometallic separation layer is applied with the help of plasma polymerization or with CVD or a combination of CVD and plasma polymerization.

22. The method of claims 11 to 14, characterized in that a separation layer, which consists of a metallic or polymeric material, is applied by suitable chemical and/or physical methods.

23. The method of claim 22, characterized in that a metallic separation layer is applied by coating or impregnating with a metal salt solution and subsequently reducing to the metal.

24. The method of claim 22, characterized in that in a polymeric separation layer is applied by coating with a monomer solution and subsequently polymerizing.

25. The method of claim 20, characterized in that an organic layer is pyrolyzed at a reduced oxygen partial pressure and a carbon layer is formed from it as separation layer.
